(19) United States
(12) Patent Application Publication
(10) Pub. No.: US 2015/0362656 A1
(43) Pub. Date: Dec. 17, 2015

(54) Light Guiding Decorative Composite Sheet and Components Made Thereof

(71) Applicants: Yu-Chen Hwang, Xinwu Township (TW); Chih En Chen, Taichung City (TW)

(72) Inventors: Yu-Chen Hwang, Xinwu Township (TW); Chih En Chen, Taichung City (TW)

(21) Appl. No.: 14/541,067

(22) Filed: Nov. 13, 2014

Related U.S. Application Data
(63) Continuation of application No. PCT/CN2014/000586, filed on Jun. 16, 2014.

(30) Foreign Application Priority Data
Jun. 16, 2014 (CN) 201410268621.8

(51) Int. Cl. F21V 8/00; B29C 59/04

(52) U.S. Cl. CPC G02B 6/0036; G02B 6/002; G02B 6/0055; G02B 6/0065; G02B 6/0068; B29C 59/046; B29L 2011/0075

(57) ABSTRACT

A light-guiding decorative lamination sheet includes a transparent substrate with concave and convex structures on the surface. An edge is thicker than center of the substrate. The cross section of the edge is in horn shape. The substrate is coated with a printed layer and a hard coat on the concave and convex surface with an adhesion layer on the other side of the substrate. The hard coat side faces to one surface of a pair of match molds and followed by a resin injection process unto the adhesion layer. The other surface of the mold may optionally have micro-structures that can be transferred to the surface of injected resin. An LED placed beside the horn shape edge forms the corresponding light-guiding composite sheet. A heat resistant layer, with softening temperature at least 10° C. higher than the injected molten resin, may be placed underneath the adhesion layer.

### RELATED APPLICATION

This application claims priority to PCT/CN2014/000586 filed on Jun. 16, 2014, that in turn claims priority to China Patent Application No. 201410268621.8, filed on Jun. 16, 2014. Additionally, this application claims priority under the Paris convention directly to China Patent Application No. 201410268621.8. The disclosures of both applications are hereby incorporated herein by reference in their entirety.

### BACKGROUND

Traditional in mold decoration (IMD) process is the integrated process of printing, thermal forming and resin injection molding. Although there are slight variations in materials used in IMR (in-mold roller)/IML (in-mold labeling)/IMF (in-mold film), the principles are still the same. In general, IMD process includes three steps: printing, thermal forming and resin inject molding. Printing process is chosen from digital printing, screen printing, tempo printing or thermo printings to result in a decorative film. Thermal forming process pre-forms the decorative film into a desired shape by applying temperature and die pressing. Resin inject molding process is to fill the cavity inside of the match mold with polymer material. The resulting parts are for decoration only, no light guiding or lighting functions.

Published Taiwan patent application 201018581 by Entire Company disclosed a substrate with surface structures for easy bending and flexibility. No stereoscopic visual effect or light guiding effects are disclosed. In order to prevent the surface structures from deformation and causing appearance issue during the resin injection process, surface structures are made of thermoset materials. Therefore, the elongation of film is limited to the thermoset surface structures. In addition, printing layer is at the opposite side to the surface structure. Therefore, no stereoscopic effect was obtained.

It is clear to see that there are needs of improving IMD film for more appealing decoration effect and retain the substrate flexibility with thermoplastic materials. These are important to expand the adoption of IMD technology to wider application range.

### BRIEF SUMMARY

In these teachings the structures and manufacturing process of light guiding decorative composite sheet and components are disclosed. In addition to surface decoration function, these components have light guiding and lighting effect. They can be used for surface decoration of cell phone, key board, notebook computer, calculator, information and communication devices, automotive, appliance, game device, housewares, stationary and sporting good's among others.

### BRIEF DESCRIPTION OF THE DRAWINGS

FIG. 1 is a structural diagram showing straight external printed decoration sheet.

FIG. 2 is a structural diagram showing a variation of straight external printed decoration sheet of FIG. 1.

FIG. 3 is a schematic diagram showing a component made of straight external printed decoration sheet FIG. 2.

FIG. 4 is a schematic diagram showing a component made of straight inner printed decoration sheet.

FIG. 5 is a schematic diagram showing a component made of horn shape decoration sheet.

FIG. 6 is a schematic diagram showing a variation of component FIG. 3 with single-sided structured plastic part.

FIG. 7 is a schematic diagram showing a variation of component FIG. 3 with double-sided structured plastic part.

### DESCRIPTION OF KEY ELEMENTS

1: single sided structured transparent substrate
2: surface treatment layer
3: printed layer
4: hard coating layer
5: heat resistant layer
6: adhesion layer
7: double-sided structured transparent substrate
8: plastic part
9: light source
10: horn shape substrate
11: single sided structured plastic part
12: reflective layer
13: double-sided structured plastic part
100,200: straight external printed decoration sheet
300: straight inner printed decoration sheet
400: horn shape decoration sheet

### DETAILED DESCRIPTION

In these teachings a light guiding decorative lamination sheet and components made thereof have not only stereoscopic printed effect but also light guiding and lighting effects.

These teachings of light guiding decorative composite sheets are accomplished through the following methods. A light guiding decorative composite sheet comprises a transparent substrate with concave and convex surface structures. At least one edge of the transparent substrate is in horn shape at cross-section and thicker than the center area. In addition, there are a printed layer and a hard coating layer on top of the concave and convex surface structures. Further, an adhesive layer is on the other surface of the transparent substrate.

The purpose of this teaching can also be accomplished by using the prior mentioned light guiding decorative composite sheet wherein the transparent substrate has concave and convex surface structures on both sides of the transparent substrate with the surface height difference between 1 μm and 100 μm.

It is preferred that the concave and convex surface structures are selected from lines, prism, half spherical, half cylindrical, pyramidal, Fresnel structure or are a combination of two or more of the above. It is preferred that the adhesive is a hot melt adhesive.

It is preferred that the horn edge thickness of the transparent substrate is equal or larger than the diameter of light emitting diode. The diameters of LEDs are between 0.1 mm and 5 mm. The horn edge thickness is usually 0.1 mm to 7 mm that is 0 to 2 mm larger than LED diameters.

This teaching can also be accomplished through the following methods. A light guiding decorative composite sheet comprises a transparent substrate with concave and convex surface structures. At least one edge of the transparent substrate is in horn shape at cross section and thicker than the center area. In addition, there are a printed layer on top of the concave, and convex surface structures and an adhesive layer on top of the printed layer. Further, a hard coating layer is on the other surface of the transparent substrate.

The purpose of this teaching can also be accomplished by using the prior mentioned light guiding decorative composite sheet wherein the transparent substrate has concave and convex surface structures on both sides of the transparent substrate with the surface height difference between 1 μm and 100 μm.

It is preferred that the concave and convex surface structures are selected from lines, prism, half spherical, half cylindrical, pyramidal, Fresnel structure or are a combination of two or more of the above. It is preferred that the adhesive is a hot melt adhesive.

It is preferred that the edge thickness of the transparent substrate is equal or larger than the diameter of light emitting diode. The diameters of LEDs are between 0.1 mm and 5 mm. The horn edge thickness is usually 0.1 mm to 7 mm that is 0 to 2 mm larger than LED diameters. This teaching of light guiding decorative components is accomplished through the following process. A light guiding decorative component utilizes the prior mentioned light guiding decorative composite sheets with the hard coating layer facing a mold surface. A transparent resin is injected onto the adhesive layer to provide a light guiding decorative injected plastic part. Additionally, light emitting diodes are placed next to horn shape edge of transparent substrate. The density of concave and convex surface structures is not uniform, less structures close to the edge with diode. Furthermore, a heat resistant layer is located underneath the adhesive layer, wherein the heat distortion temperature of the heat resistant layer is at least 10° C. higher than the injected resin temperature.

It is preferred that the heat resistant layer has light reflective effect and is selected from translucent material, material with metal powder containing, metalized sheet or high refraction index coating materials.

It is preferred that the transparent resin is selected from polymethylmethacrylate or acrylonitrile butadiene styrene copolymers. The heat resistant layer is polycarbonate, polyurethane or acrylonitrile butadiene styrene copolymers.

This teaching of light guiding decorative components is also accomplished through the following process. A light guiding decorative component utilizes the prior mentioned light guiding decorative composite sheets with the hard coating layer facing a mold surface. A transparent resin is injected onto the adhesive layer to provide a light guiding decorative injected plastic part. In addition, the transparent resin duplicates the lens structures from the mold surface. Light emitting diodes are placed next to the resin injected plastic part. The density of lens structures is not uniform, less structures at the diode side. Furthermore, a heat resistant layer is located underneath the adhesive layer and the heat distortion temperature of the heat resistant layer is at least 10° C. higher than the injected resin temperature.

It is preferred that the edges of the injected plastic part also duplicate the lens structures from the mold.

It is preferred that the transparent resin is selected from polymethylmethacrylate or acrylonitrile butadiene styrene copolymers. The heat resistant layer is polycarbonate, polyurethane or acrylonitrile butadiene styrene copolymers.

It is preferred that the heat resistant layer has light reflective effect and is selected from translucent material, material with metal powder containing, metalized sheet or high refraction index coating materials.

This teaching of light guiding decorative components is also accomplished through the following process. A light guiding decorative component utilizes the prior mentioned light guiding decorative composite sheets with the adhesive layer bonding to the surface of a light guiding plastic part. Light emitting diodes are placed next to the horn shape edge of the transparent substrate. The density of concave and convex surface structures is not uniform, less structures close to the edge with diode.

This teaching of light guiding decorative components is also accomplished through the following process. A light guiding decorative component utilizes the prior mentioned light guiding decorative composite sheets with the adhesive layer bonding to the surface of a light guiding plastic part. There are pre-formed lens structures at one side or both sides of the light guiding plastic part. Light emitting diodes are placed next to the light guiding plastic part. The density of the lens structures is not uniform, less structures close to the edge with diode s.

A method of manufacturing prior mentioned transparent substrate with concave and convex surface structures comprising:
1. using a roller carved with concave and convex micro-structures on the roller surface to provide the corresponding reversed patterns in convex and concave shapes.
2. maintaining the roller temperature ±20° C. higher than the softening temperature of a plastic sheet.
3. pressing the heated roller over one side of the plastic sheet to duplicate the micro-structures to the plastic sheet.
4. passing the resulting plastic sheet over a chilling roller to set the micro-structures. This results in single sided structured transparent substrate.
5. followed by coating a heat resistant layer on top of the micro-structures wherein the softening temperature of the heat resistant layer is at least 10° C. higher than the temperature of second heated roller, wherein the second heated roller is also carved with micro-structures on the roller surface.
6. maintaining the temperature of the second heated roller 10° C. to 30° C. higher than the temperature of the first heated roller.
7. pressing the second heated roller over the other side of the plastic sheet to duplicate the micro-structures to the plastic sheet.
8. passing the resulting plastic sheet over a chilling roller to set the micro-structures. This results in double-sided structured transparent substrate.

It is preferred that the prior mentioned transparent substrate with concave and convex surface structures wherein the micro-structures are selected from lines, prism, half spherical, half cylindrical, pyramidal, Fresnel structure or are a combination of two or more of the above.

This teaching of light guiding decorative components has the following benefits and values. The printing is on concave and convex surface structures. The concave and convex surface not only provides the stereoscopic printed effect, but also guides the edge light source of light emitting diode to emit through the concave and convex surface. This results in a decorative composite sheet with light guiding and lighting function. This can be used for decorative housing of mobile devices. Through the integration of several lighting locations, different light colors and different light flashing mode, light guiding decorative component provides a way of communication of the devise with the users, for examples: the incoming information type, caller, important messages and etc. These teachings can be applied to surface decoration of cell phone, key board, notebook computer, calculator, information and communication devices, automotive, appliance, game device, house ware, stationary and sporting goods. In these teachings, thermoplastic surface structures are used to increase heat deformation and result in highly three-dimensional shapes. The printed layers are on the thermoplastic surface structures to provide stereoscopic printed visual effect in addition to the light guiding and lighting functions.

### EMBODIMENTS

Example embodiments of the present teachings are described below by way of seven examples. However, the present invention should be in no way restricted by the examples provided.

Light guiding decorative composite sheets are produced in the following process. The transparent substrate is a rubber modified polymethylmethacrylate (acrylic) or polycarbonate (PC). The rubber-modified acrylic is chosen from 8N material supplied by Degussa in Germany or EXN from Sumitomo Company in Japan. The polycarbonate is LC1500 supplied by Idemitsu in Japan. The transparent substrate is extruded based on the conditions recommended by suppliers. The adhesive is a hot melt adhesive made of thermoplastic polyurethane (TPU) supplied by Great Eastern Resins Industry in Taiwan. Its melt temperature is between 80° C. and 150° C. It is preferred to choose the hot melt adhesive with melt temperature at least 10° C. lower than the molten resin temperature to be injected. It is preferred to choose the heat resistant layer with a softening temperature higher than 180° C.

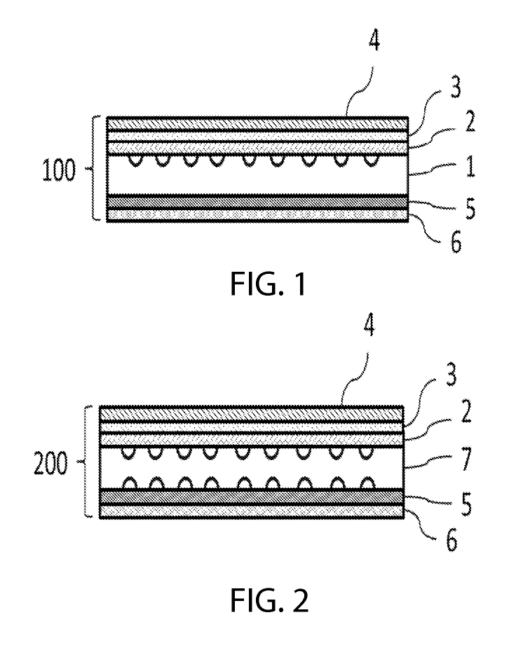

As shown in FIG. 1 and FIG. 2, a transparent substrate is an extruded acrylic film made of Degussa 8N. A roller carved with micro-structures on the roller surface maintained temperature between 80° C. and 120° C. The heated roller is pressed over the extruded acrylic film to transfer the micro-structures over the acrylic film surface. The resulting film went through a chilling roller to set the micro-structures on the film surface. It results in single sided structured transparent substrate 1. A heat resistant layer is coated on top of the set micro-structures. The softening temperature of the heat resistant layer is higher than the temperature of second heated roller which is between 90° C. and 150° C. The temperature of the second heated roller is 10° C. to 30° C. higher than the temperature of the first heated roller. Use the second heated roller over the other side of the plastic sheet to transfer the micro-structures to the plastic sheet. It results in double-sided structured transparent substrate 7. The micro-structures can be selected from lines, prism, half spherical, half cylindrical, pyramidal, Fresnel structure or are a combination of two or more of the above.

### Embodiment 1

A transparent substrate is extruded from a T-die with rubber modified acrylic film made of Degussa 8N. A heated roller with many half spherical micro-structures on surface is rolled over the rubber modified acrylic film. The roller temperature is between 80° C. and 110° C., 90° C. preferred. The resulting microlens structures are set by passing the film through a chilling roller to provide the single sided structured transparent substrate 1, as shown in FIG. 1. The resulting micro-structures have differences in lens density and surface height. The lens density is 0.01 lens/cm² with surface height difference of 5 microns at one side of the film and lens density is 0.8 lens/cm² with surface height difference of 80 microns at the other side. On the single sided structured transparent substrate 1 is coated surface treatment layer 2 which is an ultra violet (UV) curable base coat POLYCHEM #T3 50150E supplied by Poly Chem. in Taiwan. An adhesion layer 6 is heat melted laminated between 80° C. and 150° C. over the heat resistant layer 5. The adhesive is a polyurethane thermoplastic elastomer supplied by Great Eastern Resins Industry in Taiwan. A printed layer 3 is applied on surface treatment layer 2 by inkjet printing process, followed by applying an acrylic hard coating layer 4, supplied by Yu Zer Enterprise Co. in Taiwan, cured by infrared and UV to provide a surface in 3H pensile hardness. The process results in straight external printed decoration sheet 100.

### Embodiment 2

A transparent substrate is extruded from a T-die with rubber modified acrylic film made of Degussa 8N. A heated roller with many half spherical micro-structures on surface rolled over the rubber modified acrylic film. The roller temperature is between 80° C. and 110° C., 90° C. preferred. The resulting microlens structures are set by passing the film through a chilling roller to provide the single sided structured transparent substrate 1. A heat resistant layer 5 made of polycarbonate (LC1500 supplied by Idemitsu) is coated on the microlens. Second heated roller temperature is between 100° C. and 120° C. which is generally 10° C. to 30° C. higher temperature of the first heated roller. Second heated roller rolls over the other side of the single sided structured transparent substrate 1 to provide the double-sided structured transparent substrate 7, as shown in FIG. 2. The lens density is 0.01 lens/cm² with surface height difference of 5 microns at one side of the film and lens density is 0.8 lens/cm² with surface height difference of 80 microns at the other side. On one side of the double-sided structured transparent substrate 7 is coated a surface treatment layer 2 which is an ultra violet (UV) curable base coat Polychem #T3 50150E supplied by Poly Chem. Co. in Taiwan. An adhesion layer 6 is heat melted laminated between 80° C. and 150° C. over the heat resistant layer 5. The adhesive is a polyurethane thermoplastic elastomer supplied by Great Eastern Resins Industry in Taiwan. A printed layer 3 is applied on surface treatment layer 2 by inkjet printing process, followed by applying an acrylic hard coating layer 4, supplied by Yu Zer Enterprise Co. in Taiwan, cured by infrared and UV to provide a surface in 3H pensile hardness. The process results in straight external printed decoration sheet 200.

### Embodiment 3

A transparent substrate is extruded from a T-die with polycarbonate (LC-1500) supplied by Idemitsu in Japan. A heated roller with many half spherical micro-structures on surface rolls over the polycarbonate film. The roller temperature is between 70° C. and 120° C., 90° C. preferred. The resulting microlens structures are set by passing the film through a chilling roller. Second heated roller temperature is between 130° C. and 180° C. and rolls over the other side of the polycarbonate film to provide the double-sided structured transparent substrate 7, as shown in FIG. 2. The lens density is 0.01 lens/cm² with surface height difference of 5 microns at one side of the film and lens density is 0.8 lens/cm² with surface height difference of 80 microns at the other side. On one side of the double-sided structured transparent substrate 7 is coated a surface treatment layer 2 which is an ultra violet (UV) curable base coat Polychem #T3 50150E supplied by Poly Chem. Co. in Taiwan. A printed layer 3 is applied on surface treatment layer 2 by inkjet printing process, followed by heat laminating an adhesion layer 6 between 80° C. and 150° C. The adhesive is a polyurethane thermoplastic elastomer supplied by Great Eastern Resins Industry in Taiwan. An acrylic hard coating layer 4, supplied by Yu Zer Enterprise Co. in Taiwan, is applied on the other side of double-sided structured transparent substrate 7. It is cured by infrared and UV to provide a surface in 3H pensile hardness. The process results in straight inner printed decoration sheet 300, as shown in FIG. 4.

### Embodiment 4

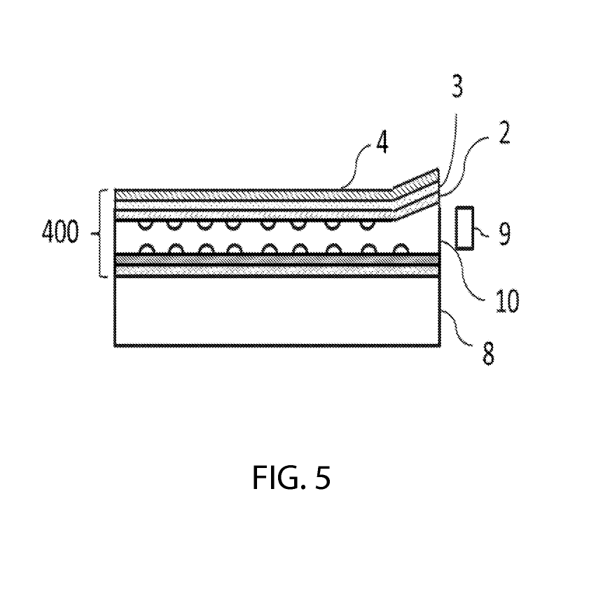

The process in Embodiment 2 is used, but the T-die is changed to an extrusion die with the one edge in trapezoid shape. The extruded film has a horn shape cross-section. A narrow heated carved roller is used to avoid the horn shape area. The roller is carved with half spherical lenses. The rest of process is the same with Embodiment 2 to produce a horn shape decoration sheet 400, as shown in FIG. 5. The horn edge thickness is between 0.1 mm and 7 mm.

### Embodiment 5

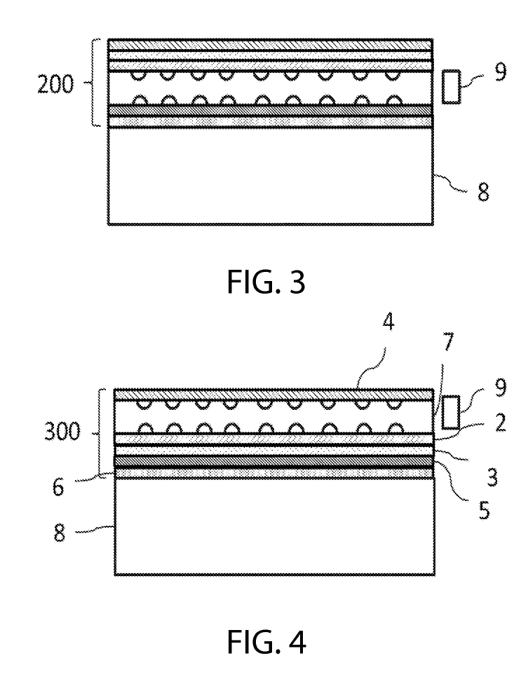

Decoration sheets produced from Embodiments 1 to 4 are used, and the hard coating layer 4 is faced toward the mold surface. An acrylic resin of 8N supplied by Degussa, or acrylonitrile butadiene Styrene copolymers is injected into the mold cavity and adhered to the adhesion layer 6 to form a light guiding decorative plastic part 8, single sided structured plastic part 11 and double-sided structured plastic part 13 respectively. Light source 9 of 4 mm light emitting diodes (LEDs), 59-146UTD/TR8 supplied by Ever Lighting Corp. in Taiwan, are placed at one side of single sided structured transparent substrate 1 or double-sided structured transparent substrate 7. The side with LEDs has less lens density and less height difference on the surface of transparent substrate. This process results in light guiding decorative components shown in FIGS. 3 to 5.

### Embodiment 6

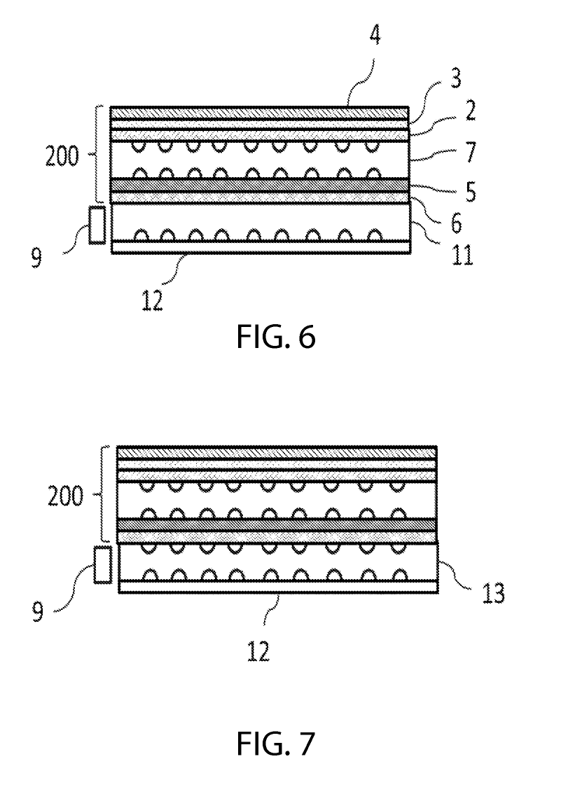

A match mold with one mold surface containing half spherical microstructure is used. The decorative composite sheets produced from Embodiment 1 to 4 are used with the hard coating layer 4 facing toward the mold surface without micro-structures. Then the mold is closed, Rubber modified acrylic, 8N supplied by Degussa, or acrylonitrile butadiene styrene copolymers is injected into the mold cavity and adhered to the adhesive layer 6 to form a light guiding decorative plastic part. Light source 9 of 4 mm light emitting diodes (LEDs), 59-146UTD/TR8 supplied by Ever Lighting Corp. in Taiwan, are placed at one side of single sided structured plastic part 11. The side with LEDs has less lens density and less height difference on the surface of plastic part. This process results in light guiding decorative component shown in FIG. 6.

### Embodiment 7

The decoration sheets produced from Embodiments 1 to 4 are used and adhered to pre-formed double-sided structured plastic part 13 made of acrylic 8N supplied by Degussa. Light source 9 of 4 mm light emitting diodes (LEDs), 59-146UTD/TR8 supplied by Ever Lighting Corp. in Taiwan, are placed at one side of double-sided structured plastic part 13. The side with LEDs has less lens density and less height difference on the surface of plastic part. This process results in light guiding decorative components shown in FIG. 7.

Moreover, as those of skill in this art will appreciate, many modifications, substitutions and variations can be made in and to a method of making light guiding decorative composite sheet or components of these example embodiments without departing from its spirit and scope. In light of this, the scope of the present invention should not be limited to that of the particular embodiments illustrated and described herein, as they are only exemplary in nature, but instead, should fully commensurate with that of the claims appended hereafter and their equivalents.

### ASPECTS OF THE INVENTION

Aspects of the present invention comprise:
1. A light guiding decorative composite sheet comprising a transparent substrate with concave and convex surface structures, wherein at least one edge of the transparent substrate is in a horn shape at cross-section and thicker than the center area of the sheet, wherein there is a printed layer and a hard coating layer on top of the concave and convex surface structures, wherein an adhesive layer is on the opposite surface of the transparent substrate.
2. A light guiding decorative composite sheet comprising a transparent substrate with concave and convex surface structures, wherein at least one edge of the transparent substrate is in a horn shape at cross-section and thicker than the center area of the sheet, wherein there is a printed layer on top of the concave and convex surface structures and an adhesive layer on top of the printed layer, wherein a hard coating layer is on the opposite surface of the transparent substrate.
3. A light guiding decorative component utilizing the light guiding decorative composite sheet of aspects 1 and 2 wherein the hard coating layer faces a mold surface and a heated transparent resin is injected onto the adhesive layer to provide a light guiding decorative injected plastic part,
   wherein light emitting diodes are located next to the horn shape edge of the transparent substrate,
   wherein the density of concave and convex surface structures is not uniform, having less structure close to the edge with diode,
   wherein a heat resistant layer is located underneath the adhesive layer and the transparent substrate,
   wherein the heat distortion temperature of the heat resistant layer is at least 10° C. higher than the injected resin temperature.
4. The light guiding decorative component of aspect 3 wherein the heat resistant layer has light reflective effect and is selected from translucent material, material with metal powder containing, metalized sheet and high refraction index coating materials.
5. The light guiding decorative component of aspect 3 wherein the transparent resin is selected from polymethylmethacrylate or acrylonitrile butadiene Styrene copolymers,
   wherein the heat resistant layer is polycarbonate, polyurethane and acrylonitrile butadiene Styrene copolymers.
6. A light guiding decorative component utilizing the light guiding decorative composite sheet of aspects 1 and 2 wherein the hard coating layer faces a mold surface and a heated transparent resin is injected onto the adhesive layer to provide a light guiding decorative injected plastic part,
   wherein the transparent resin duplicates the concave and convex surface structures from the mold surface,
   wherein light emitting diodes are located next to the resin injected plastic part,
   wherein the density of concave and convex surface structures is not uniform, with less structure close to the edge with diode,
   wherein a heat resistant layer is located underneath the adhesive layer,
   wherein the heat distortion temperature of the heat resistant layer is at least 10° C. higher than the injected resin temperature.
7. The light guiding decorative component of aspect 6 where the edges of the injected plastic part also duplicate the concave and convex surface structures from the mold.
8. The light guiding decorative component of aspect 6 wherein the transparent resin is selected from polymethylmethacrylate or acrylonitrile butadiene styrene copolymers,
   wherein the heat resistant layer is polycarbonate, polyurethane or acrylonitrile butadiene styrene copolymers.
9. The light guiding decorative component of aspect 6 wherein the heat resistant layer has light reflective effect and is selected from translucent material, material with metal powder containing, metalized sheet or high refraction index coating materials.
10. A method of manufacturing a transparent substrate with concave and convex surface structures of aspect 1 comprising:
   using a heated roller carved with concave and convex micro-structures on the roller's surface,
   maintaining the roller's temperature ±20° C. higher than the softening temperature of a plastic sheet,
   pressing the heated roller over one side of the plastic sheet to duplicate the micro-structures to the plastic sheet,
   passing the resulting plastic sheet over a chilling roller to set the micro-structures to provide single sided structured transparent substrate,
   followed by coating a heat resistant layer on top of the micro-structures wherein the softening temperature of the heat resistant layer is at least 10° C. higher than the temperature of second heated roller, wherein the second heated roller is also carved with micro-structures on the second roller's surface,
   maintaining the temperature of the second heated roller 10° C. to 30° C. higher than the temperature of the first heated roller,
   pressing the second heated roller over the other side of the plastic sheet to duplicate the micro-structures to the plastic sheet,
   passing the resulting plastic sheet over a chilling roller to set the micro-structures to provide double-sided structured transparent substrate.
11. The method of manufacturing a transparent substrate of aspect 10 wherein the micro-structures on the first and on the second rollers are separately selected from line, prism, half spherical, half cylindrical, pyramidal, Fresnel structure or are a combination of two or more of the above.

What is claimed is:

1. A light guiding decorative composite sheet comprising a transparent substrate with concave and convex surface structures,
wherein at least one edge of the transparent substrate is in a horn shape at cross-section and thicker than the center area of the sheet,
wherein there is a printed layer on top of the concave and convex surface structures,
wherein a hard coating layer and an adhesive layer are on the opposite surfaces of the transparent substrate.

2. The light guiding decorative composite sheet of claim 1, wherein the hard coating layer is on top of the printed layer.

3. The light guiding decorative composite sheet of claim 1, wherein the adhesive layer is on top of the printed layer.

4. The light guiding decorative composite sheet of claim 1, wherein the transparent substrate has concave and convex surface structures on both sides of the transparent substrate with the surface height difference between 1 μm and 100 μm.

5. The light guiding decorative composite sheet of claim 1, wherein the concave and convex surface structures are selected from line, prism, half-spherical, half-cylindrical, pyramidal, Fresnel structure or comprise two or more of the above surface structures.

6. The light guiding decorative composite sheet of claim 1, wherein the adhesive is a hot melt adhesive.

7. The light guiding decorative composite sheet of claim 1, wherein the thickness of the horn shaped edge of the transparent substrate is between 0.1 mm and 7 mm.

8. A light guiding decorative component utilizing the light guiding decorative composite sheet of claim 1 wherein the hard coating layer faces a mold surface and a heated transparent resin is injected onto the adhesive layer to provide a light guiding decorative injected plastic part,
wherein light emitting diodes are located next to the horn shape edge of the transparent substrate,
wherein the density of concave and convex surface structures is not uniform, having less structure close to the edge with diode,
wherein a heat resistant layer is located underneath the adhesive layer,
wherein the heat distortion temperature of the heat resistant layer is at least 10° C. higher than the injected resin temperature.

9. The light guiding decorative component of claim 8 wherein the heat resistant layer has light reflective effect and is selected from translucent material, material with metal powder containing, metalized sheet and high refraction index coating materials.

10. The light guiding decorative component of claim 8 wherein the transparent resin is selected from polymethylmethacrylate or acrylonitrile butadiene Styrene copolymers,
wherein the heat resistant layer is polycarbonate, polyurethane and acrylonitrile butadiene styrene copolymers.

11. A light guiding decorative component utilizing the light guiding decorative composite sheet of claim 1 wherein the hard coating layer faces a mold surface and a heated transparent resin is injected onto the adhesive layer to provide a light guiding decorative injected plastic part,
wherein the transparent resin duplicates the concave and convex surface structures from the mold surface,
wherein light emitting diodes are located next to the resin injected plastic part,
wherein the density of concave and convex surface structures is not uniform, with less structure close to the edge with diode,
wherein a heat resistant layer is located underneath the adhesive layer,
wherein the heat distortion temperature of the heat resistant layer is at least 10° C. higher than the injected resin temperature.

12. The light guiding decorative component of claim 11 where the edges of the injected plastic part also duplicate the concave and convex structures from the mold surface.

13. The light guiding decorative component of claim 11 wherein the transparent resin is selected from polymethylmethacrylate or acrylonitrile butadiene styrene copolymers,
wherein the heat resistant layer is polycarbonate, polyurethane or acrylonitrile butadiene styrene copolymers.

14. The light guiding decorative component of claim 11 wherein the heat resistant layer has light reflective effect and is selected from translucent material, material with metal powder containing, metalized sheet or high refraction index coating materials.

15. A light guiding decorative component utilizing the light guiding decorative composite sheet of claim 1 wherein the adhesive layer is bonded to the surface of a light guiding plastic part,
wherein light emitting diodes are placed next to the horn shape edge of the transparent substrate,
wherein the density of concave and convex surface structures is not uniform, having less structure close to the edge with diode.

16. A light guiding decorative component utilizing the light guiding decorative composite sheet of claim 1 wherein the adhesive layer is bonded to the surface of a light guiding plastic part,
wherein there are pre-formed lens structures at one side or both sides of the light guiding plastic part,
wherein light emitting diodes are placed next to the light guiding plastic part,
wherein the density of the lens structures is not uniform, less structures at the diode side.

17. A method of manufacturing a transparent substrate with concave and convex surface structures of claim 1 comprising:
using a heated roller carved with concave and convex micro-structures on the roller's surface,
maintaining the roller's temperature ±20° C. higher than the softening temperature of a plastic sheet,
pressing the heated roller over one side of the plastic sheet to duplicate the micro-structures to the plastic sheet,
passing the resulting plastic sheet over a chilling roller to set the micro-structures to provide single sided structured transparent substrate,
followed by coating a heat resistant layer on top of the micro-structures wherein the softening temperature of the heat resistant layer is at least 10° C. higher than the temperature of second heated roller, wherein the second heated roller is also carved with micro-structures on the second roller's surface,
maintaining the temperature of the second heated roller 10° C. to 30° C. higher than the temperature of the first heated roller,
pressing the second heated roller over the other side of the plastic sheet to duplicate the micro-structures to the plastic sheet,
passing the resulting plastic sheet over a chilling roller to set the micro-structures to provide double sided structured transparent substrate.

18. The method of manufacturing a transparent substrate of claim 17 wherein the micro-structures on the first and on the second rollers are separately selected from line, prism, half spherical, half cylindrical, pyramidal, Fresnel structure or are a combination of two or more of the above.
